(19) United States
(12) Patent Application Publication
(10) Pub. No.: US 2024/0319954 A1
(43) Pub. Date: Sep. 26, 2024

(54) MULTIFUNCTIONAL INFORMATION AND COMMUNICATION PLATFORM WITH INTELLIGENT INFORMATION MANAGEMENT

(71) Applicant: Zhanat MALBEKOV, Almaty (KZ)

(72) Inventor: Zhanat MALBEKOV, Almaty (KZ)

(21) Appl. No.: 18/578,756

(22) PCT Filed: Jul. 14, 2021
(86) PCT No.: PCT/KZ2021/000017

§ 371 Date: Jan. 12, 2024

(51) Int. Cl. G06F 3/147; G06Q 30/0251; G09F 9/30

(52) U.S. Cl. CPC G06F 3/147; G09F 9/30; G06Q 30/0261

(57) ABSTRACT

The invention relates to the field of automatically collecting, processing, analyzing, classifying, managing, generating, storing, protecting and outputting information. Claimed is a multi-functional information and communication platform with intelligent information control, comprising a central computer and, arranged along the travel path of users, media boards containing devices for collecting, transmitting, receiving and displaying information, digital video controllers, a media board onboard computer, and transceiving devices for wired or wireless communication with the central computer, wherein the platform further comprises devices for detecting radio signals and for recognizing users and their movements (personalization devices), and is a hardware and software system. Devices for displaying information are comprised of multiple sectors, and media boards are joined into clusters.

### FIELD OF THE INVENTION

The invention relates to the field of automated information collecting, processing, analyzing, classifying, managing, generating, storing, protecting, and outputting.

### BACKGROUND OF THE INVENTION

A known intelligent information system (IIS) for a city comprises digital video controllers and transmitting and transmitting devices of wired or wireless communication installed on roads and transport lines, as well as a central computer storing the information being transmitted. The system is a hardware-software system for processing video streaming information from a single network platform and a built-in LED monitors structure containing software of analytical functionality of the system for collecting, processing, and transmitting data; the active area of LED monitors is visually divided into navigation, information, and advertising blocks for transmitting a full-value high-quality image of both static and video dynamic content. The information can be placed in both the navigation and information blocks individually in each block or two blocks simultaneously; besides, all three blocks can be used simultaneously. The video controllers include voltage sensors that inform the dispatcher about the lack of power, as well as have the functions of internal climate control and automatic exit to reboot mode when hang-up or loss of network signal and possible parameters of connection to the WLAN with an external antenna, LAN and 3G, 4G, LTE networks, and logging actions.

The disadvantage of the known system is its limited functionality, insufficient volume of the provided information, and the complete absence of orientation on a certain user.

### OBJECT AND SUMMARY OF THE INVENTION

The object of the claimed invention is to expand the platform possibilities, increase the capabilities of collecting, processing, and providing information to users, as well as generating relevant information (content) and intelligent management of information for publishing it at the required time and in the right place as personalized for people in a certain information event process, as well as providing more detailed information targeted at a particular user (personification of the information provided).

The implementation of a multifunctional information and communication platform with intelligent information management provides for the construction of an efficient information ecosystem in a megalopolis as one of the components of the Smart City principle; the development of physical, digital, and communication infrastructure in an urban environment for the information support of a city with relevant, up-to-date, and controlled information.

The platform is a single convergent interacting, inter-penetrating information ecosystem with distributed tasks; it is a complex hardware and software solution consisting of a network of information display devices combined into a single cluster or multiple clusters controlled by the central computer.

Integration of various hardware and software complexes performs automated generation and intelligent management of current information within a cluster of information display devices based on determining platform functions such as:
A discrete description of a targeted event city information;
Automated generation of information and commercial content;
Intelligent management of information by addressing actual, predicted, or modeled events;
Targeted information support for people and information support for infrastructure facilities;
Adaptive, multi-format, and multi-sectoral broadcast in various information systems.

### DESCRIPTION OF THE INVENTION

### The Platform is an Interactive Media Tool for Urban Space.

Multifunctional and cross-platform technology solutions provide highly efficient communication in the urban space for public convenience. They detect trends in events and make independent decisions to optimize the management and regulation of traffic and pedestrian flows by visual navigation methods.

The platform process solution adds to the infrastructure of the Intelligent City Transport System, creating a uniform information and communication system that provides for indirect and directive control of traffic flows.

The main task of the platform in the infrastructure of the Intelligent Transport System is to optimize traffic flows in the urban space through adaptive regulation of vehicles and information interaction with drivers along the way, increasing traffic safety by independent analysis of targeted data and identification of abnormal and incident events for timely, real-time alert of drivers about the current situation in the road segments. The network of mediaboards and variable information boards allows for: navigation orientation and information tracking of drivers and pedestrians in the city; providing information on parking places; informing about the nearest significant objects, street names indicating directions, weather conditions, air quality, and currency rates.

As an infrastructure addition to ITS, the platform monitors the traffic flow using the onboard analytical systems. The platform uses reactive and active information processing techniques to support data aggregation, collection and analysis, and predictive and online information modeling.

Multiple processed parameters allow for centralized management of infrastructure entities and provide direct and indirect traffic control in the city. Among other things, they provide:
Vehicle traffic regulation by notifying about changes in the speed limits, displaying the recommended speed limit;
Informing about current situations on the road sections—traffic conditions on the road, category of jams, state of the road (snow, rain, ice); road sections with difficult traffic, detour schemes;
Current information through aggregating data from various analytical equipment, city services, and information services through up-to-date and urgent messages about operational road information, timely warning of emergencies, and priority passage for special transport.

The platform increases road traffic safety by:
Increasing the drivers' attention on dangerous and critical road sections by dynamic information;
Synchronization of school schedules with the signs of “CAUTION, CHILDREN” on the mediaboards;
Detecting vehicle parameters to account for and ensure complex road safety;

The communicative platform format develops the city visual communication system, provides navigation orientation, and information-cognitive tracking of guests and city residents by broadcasting through the network of pedestrian mediaboards and information panels the significant and necessary information in several languages, including:
Broadcasting controlled information and dynamic control of pedestrian traffic.
Broadcasting primary, event, and relevant urban information for pedestrians, such as street names, closely located objects; taxi and public transport stops; navigation information with estimated route parameters; urban events and events; relevant and urgent information.
Accessible communication and on-demand services.
On-demand translation service.
Personification of information provided on interactive request, including:
   Targeted information support;
   Addressing information on interactive requests;
   Interaction with a mediaboard to receive personalized information and system services;
   Remote interactive information support and navigation orientation for pedestrians.

The platform ensures public safety through dynamic pedestrian traffic control in an abnormal situation or incident in a limited space.

In crowded places (tourist areas, cultural-sports venues, public places), the platform increases the level of safety of city residents and guests in ordinary situations and emergencies:
Ensuring public safety in limited spaces through dynamic information control of pedestrian traffic.
Ensuring public safety in emergencies by providing an alarm button on the mediaboards for an urgent emergency request.
The instrumental equipment for interactive interaction of people with mediaboards using contactless remote communication methods ensures their health safety.

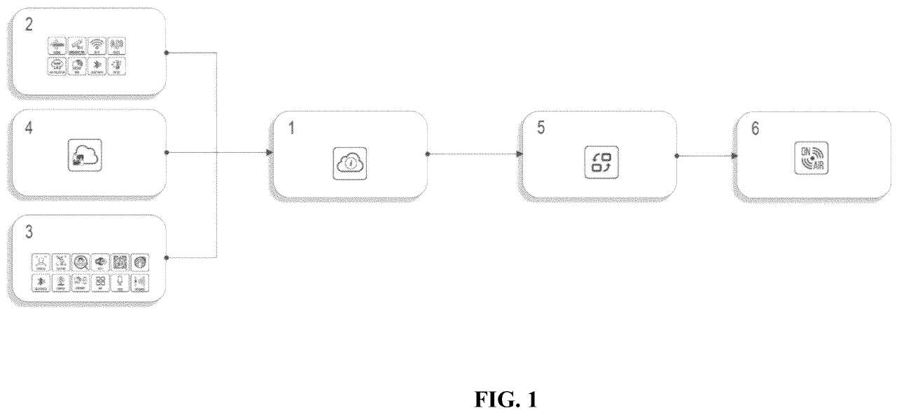

For that purpose, the claimed multifunctional information and communication platform includes a central computer and various information collection devices (sensors) and information panels. The information collection and display devices can be independent or combined into stationary units, mediaboards equipped with devices, and onboard computers for collecting, primary processing, storage, transmitting to the central computer, and outputting the information content to information display devices. The platform is a hardware and software complex (FIG. 1) consisting of the following components:
A software complex for the generation and intelligent management of information, with visualization of information flows (1);
An analytical equipment complex for information collection and processing;
User interaction instrumentation;
Integration platform software for aggregating external data and information (4);
A set of equipment that makes up the control system architecture and includes onboard media computers and the central computer (5);
An information display device equipment complex (6).

The software complex includes:
a decision module
an event modeling module
an event prediction module
an automated content generation module
an intelligent information management module
a module for outputting content to an information display device
a telemetry module
a client portal
an administrative panel, and
a database.

The software complex is designed to receive and process information, generate and self-decide, manage information, and display information content based on aggregation and processing of data coming from other hardware and software components of the platform and has the function of intelligent information management based on multiple parameters. The software complex also performs semi-automated and automated media planning, providing maximum advertising campaigns efficiency for advertisers.

Depending on the generation method, the information content of the platform is divided into automatic, semi-automatic, and modified content.

Automated content includes information, widgets, and media messages formed by automated content construction software based on the aggregated information.

Semi-automated content includes information, widgets, and media messages generated manually with the direct support of content-building software.

Moderated content includes ready-made information, widgets, and media messages that have undergone selection, negotiation, and adaptation through a moderation service for compliance with the internal requirements of the platform.

The generated information is controlled by predictive modeling and analytical processing based on collecting and processing multiple parameters, such as accumulated statistics, real-time event, and incident data, city data, network technical condition parameters, meteorological data, etc., for dynamic control information content.

Publication and placement of content on various display devices are performed by intelligent information management algorithms based on broadcast functionality, such as broadcast region, broadcast volume, broadcast period, broadcast frequency, content broadcast information field sector on a display device, targeted contact, and the like, defined by the software complex for each information content on the platform.

The analytical equipment complex includes a local mediaboard computer, digital cameras with a video analytics function, meteorological sensors (temperature, pressure, humidity, precipitation, air pollution, etc.), transceiver devices with Wi-Fi, Bluetooth, RFID, and NFC radio signal detection function, and radar.

The analytical equipment complex is a hardware and software solution based on various wireless technologies for collecting and processing the variable data used by analytical and interactive systems for automated generation and intelligent management of information and increasing security.

Data collection, processing, and accumulation are performed continuously over time online.

Distributed and dispersed analytical equipment complexes making part of the mediaboards continuously detect and identify vehicles, people, and radio-frequency emitting devices in their coverage area.

The analytical equipment complex collects primary incoming information, processes, stores, and transmits it to the central computer and the software complex for further processing and output to the information display device.

In addition to the information processed by the software complex, the information content can contain information received from a central computer and generated based on aggregating and processing data coming from other hardware and software components of the platform, such as the integration complex for aggregating external data, including information output by the operator in manual mode through the central computer, also remotely.

The analytical equipment complex processes the collected information and generates targeted data using artificial intelligence technology. The collected information is processed, filtered, stored, and transmitted to the central computer. Artificial intelligence ensures that only data required for the data system is processed and transmitted while unnecessary information is filtered and discarded.

The platform performs intelligent information management with an indirect personification of actual, predicted and modeled events for efficient and targeted communication based on analytical processing of data and various accumulated statistical data sets, event and incident parameters using mathematical modeling methods. Indirect personification produces a discrete description of actual event processes or predicted events at a particular location and at a certain time, which are relevant to a group of people or one person accidentally located at this time and in this place of the event process. This described event is personalized and relevant only for that group of people (the person). For other groups of people in other times and places, this information is unrelated to their information processes and events, so they are provided with other relevant information.

Functions performed by the analytical equipment complex:
Calculating the identified traffic statistics in the effective viewing area.
Calculating the amount of background radio emission signals from communication devices during the content broadcasting to personify the content provided.
Accounting for the total number of contacts for different content on the platform.
Account of the number of IDs re-contacting the platform content.
Accounting of targeted contacts with the platform content.
Registration, accounting, and verification of the electronic device IDs for personalized information support.

The analytical equipment complex generates the following parameters for fixation (storage) and output to the information display device:
Vehicle flow density;
Average speed rate;
Traffic jam level;
Traffic intensity;
Number of vehicles;
The number of contacts for each content;
Vehicle license plate
Actual vehicle speed;
The date of fixation of each vehicle;
Time of fixation of each vehicle;
Number of MAC addresses of emitting devices;
IDs of electronic devices;
Weather data

Software of the analytical complex outputs a portion of obtained and processed information to the information display. Furthermore, information from an external source, a remote computer connected over a network (wired or wireless), including manual input by an operator, can be output to the information display when necessary.

The user interaction instrumentation Includes:
1. Speech analyzer unit
2. Wi-Fi sniffer
3. Bluetooth sniffer
4. Facial Recognition Device
5. Human Motion Identification Cameras
6. Vehicle identification and motion parameters' camera
7. User gesture control unit
8. QR and bar code readers
9. RFID and NFC readers
10. Touchscreen (sensor) panel
11. Quasi-sensor control panel
12. Button (Keyboard) Control
13. Positive displacement sensor

The user interaction instrumentation provides direct contact of the system with the targeted audience for personalized information services, interactive information support, and human tracking using various wireless and non-contact technologies.

Ways and methods of direct hardware interaction of the system and people are used to personify information on interactive requests. These ways and methods include:
remote identification methods;
methods of short-range contactless identification;
contact identification methods;
optical biometric identification methods;
acoustic identification method;
methods of identifying kinematic motion;
contact request methods.

Remote identification (remote) identification methods are based on the following:
Detecting BLUETOOTH MAC addresses of emitting devices with remote identification threshold by RSSI signal level
Detecting WI-FI MAC addresses of emitting devices with remote identification threshold by RSSI signal level
Absolute geolocation thresholds for a response from user smartphones or communication operators
Algorithms and methods for detecting relative geo-positioning of a user's radio-emitting device

This includes detecting and verifying user device IDs previously registered in the system. As a user approaches a sensor or mediaboard and steps into the approach area configured on the platform, the mediaboard reacts by providing personalized navigation and information support data according to the tasks previously configured in the system and relevant at that time and location.

The methods of short-range contactless identification are based on the following:
RFID tags registration
NFC tags registration
Registering BLUETOOTH MAC addresses of emitting devices with short-range identification threshold by RSSI signal level
Registering WI-FI MAC addresses of emitting devices with short-range identification threshold by RSSI signal level

The ID of the address is verified by the central computer when the mediaboard device reads the user's RFID tag media (RFID or NFC tickets or cards).

The mediaboard then reacts by providing personalized information of navigation-and-information support data according to the tasks previously configured in the system and relevant at that time and location.

Contact identification based on physical contact for reading ID data from the user's digital media, such as:
Reading ID from magnetic media on cards
Reading ID from microchips on user credentials

At that, the system verifies an ID when reading it from the user's digital media. The information display device then reacts by providing personalized information for navigation and information support according to the tasks previously configured in the system and relevant at that time and location.

Optical identification methods are based on the following:
Recognition of vehicle license plates and types
Biometric recognition of faces
Recognition of QR and bar codes

When a user approaches a mediaboard and enters the vehicle license plates' optical capture area, the face biometric identification zone or attaches a QR or barcode to the reader, the parameters of the TS, the user's face, and codes are verified in the system. The mediaboard or the nearest information display device then reacts by providing personalized information for navigation and information support according to the tasks previously configured in the system and relevant at that time and location.

The voice request acoustic identification method is based on an automatic speech recognition system, methods of converting audio signals into text, and parsing keywords to produce inquiries in the system.

After accessing the system, the user posts a voice inquiry to search for certain information or types of information services via the active surface on the information display device.

Optical identification of human motion kinematics is based on recognizing motion vectors of selected human body objects to control selection and requesting the desired in the system browser.

After accessing the system, the search and inquiry for information are managed by movements of the user's body parts or gestures of the fingers and hands.

Next, the information display device reacts by providing the desired information or rendering information services.

Contact request methods are based on the following:
Sensor (TOUCHSCREEN) solutions,
Quasi-touch contacting
Tactile contact interaction

In this case, the user requests the desired information and digital services on the platform through the active surface of the information display device or the contact interaction sector. Next, the information display device reacts by providing the desired information or rendering digital services.

The user interaction instrumentation performs the following types of interaction:
Providing targeted information;
Addressing and personification information on interactive requests;
Full and detailed disclosure of raw data in the system upon request.
Request and provision of personalized information services.
Request and provision of emergency assistance in the system
Request and provision of language translation functions
Request and provision of broadcasts in the targeted view mode on interactive request
The request and performance of entertainment, cognitive, production, and functional activities based on optical identification, biometrics, and human kinematics methods
Interaction with a mediaboard to receive personalized system services;
Making personal payments by types of services provided via mediaboards (payment for services, tickets, etc.)
Making payments from wireless cards by limited transactions using mediaboard devices;
Remote interactive information support and navigation orientation for pedestrians;
Providing personalized information and navigation support via mediaboards
Personalized information and navigation support via PUSH notifications on mediaboards
Broadcasting controlled information and dynamic control of pedestrian traffic.

A user shall register in the system and determine information support tasks to receive interactive information support.

There are several ways a user can register in the system:
CENTRALIZED registration in the system is performed during dispensing, issue of documents (passes, tickets, travel tickets, registration cards fitted with QR and bar codes, documents with radio frequency marks, license plate numbers, etc.), and registration of radio-emitting devices with setting system tasks for information support.
REMOTE registration of a device ID is performed at remote access to the platform, via service applications, with setting tasks for personalized information support of the responses and inquiries.
LOCAL registration is performed via the mediaboard by initiating access to the system through active mediaboard surfaces or remote communication methods, with a personalized selection of information support tasks upon request, followed by registration of the user device ID in the system or recording and verification of the user's biometric data via the mediaboard.

Integration platform software for aggregating external data collects and processes external data from information portals (mediaboards and other devices). The OpenAPI protocol serves for external data reception.

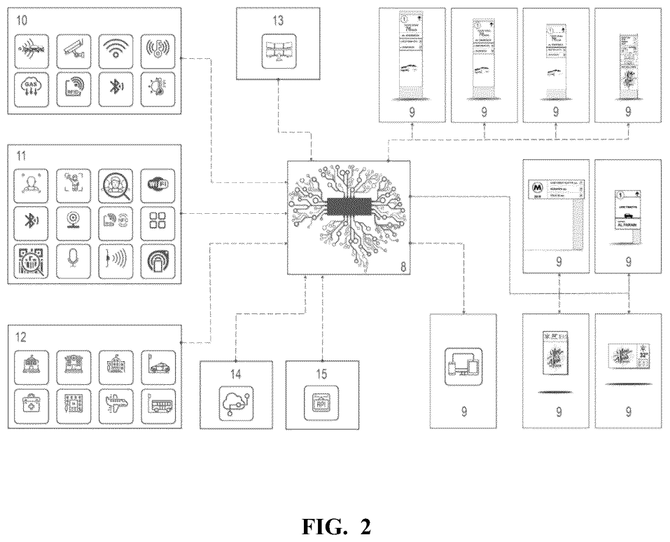

The equipment complex making up the platform devices' control system architecture (FIG. 2) consists of onboard computers of the mediaboards (9) and the central (coordination) computer (8) controlled by the relevant software.

A mediaboard computer makes an integral part of each mediaboard (9). A mediaboard computer is configured to transmit a signal to the mediaboard information display device, monitor the technical condition of the display device equipment, and communicate with the central computer.

The central (coordination) computer is the main processor of the platform. The central computer performs intelligent information generation and control on mediaboard computers, collects and processes information from various external information flows coming from:
The analytical equipment complex (10);
The user interaction instrumentation (11);
Municipal services (12);
Event center (13);
Online services (14);
Open API (15).

The information display device equipment complex is a finite platform element that translates generated and dispersed information content. The information display devices include:
Variable message signs (VMS);
Visual displays of dynamic information (VDDI);
Digital video screens of various formats, designs, and functional purposes;
Media facades of buildings and structures of various configurations and solutions;
Television, industrial, and professional display devices of various sizes and formats;
Information mediaboards of various formats.

Information display devices may include one or more fields (blocks) for displaying various content. Platform processing solutions may provide certain broadcast formats for various types of information display devices.

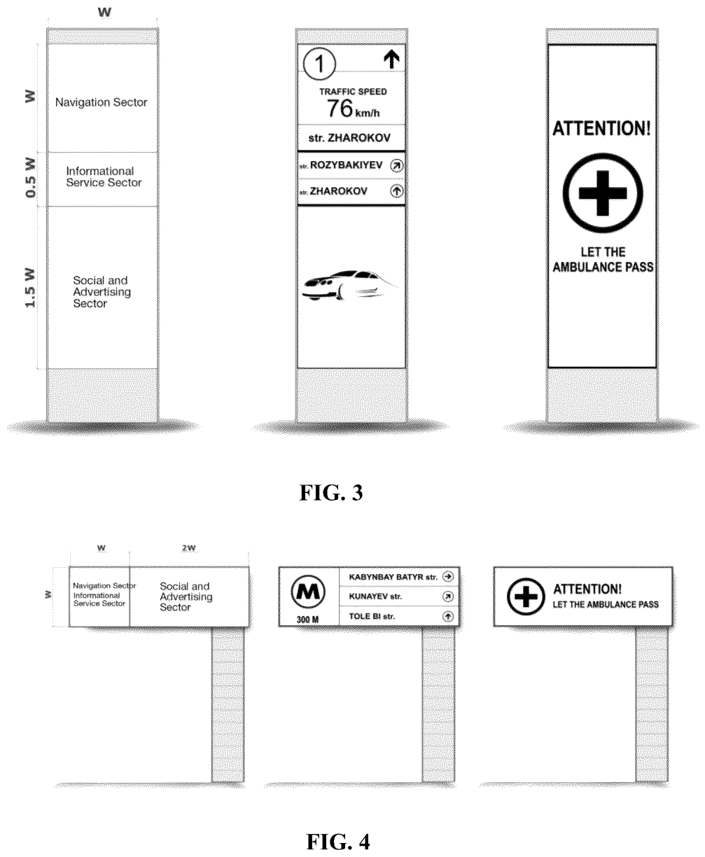

The platform is based on standard single-sector and multi-sectoral broadcast formats to ensure the quality and efficiency of information broadcasting. For example, the multi-sectoral format includes such information complexes as vertical roadside structures of trunk, road, street, and pedestrian mediaboards, which contain three information sectors on one surface (FIG. 3):
Navigation sector;
Service information sector;
Sector for social and commercial information.

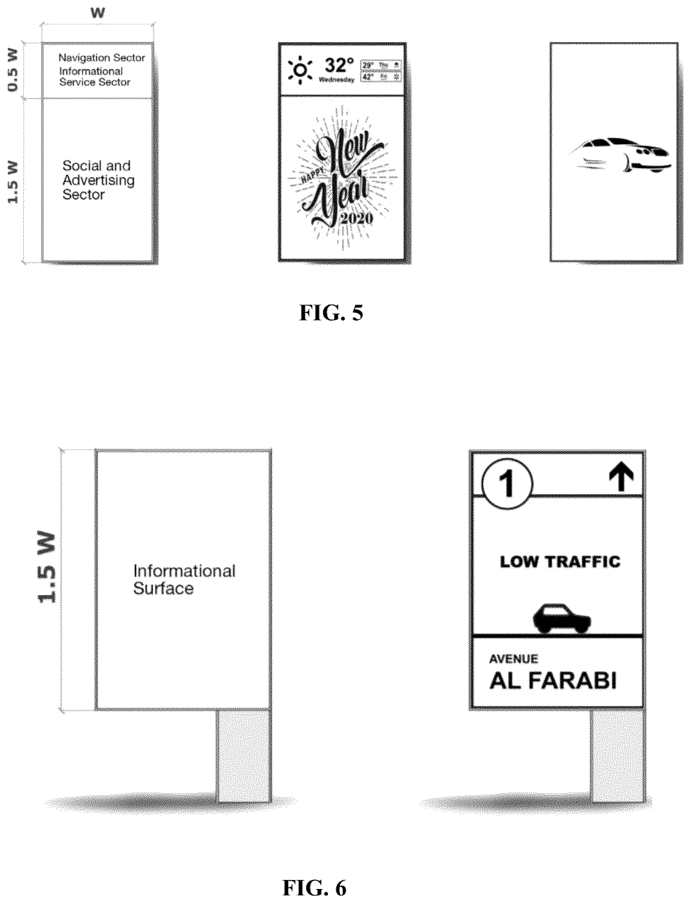

Horizontal roadside mediaboard structures (FIG. 4) and information display devices (FIG. 5) have two information sectors on one surface:
Navigation and service information sector;
Sector for social and commercial information.

Information can be displayed in navigation, information, and commercial areas separately or in two or three sectors at a time with partial or complete overlapping of all sectors. For example, when drivers are alerted about the need to give way to special transport (an ambulance), etc., utilizing the entire information surface of the mediaboard. In this case, the platform determines the priority of information content for broadcasting based on its relevance as specified or set by the platform.

Algorithms for the dynamic changing of dimensions of broadcast areas can be applied to emphasize and draw attention to relevant information on a multi-sectoral information surface.

The single-sector format includes single-sector structures with the entire information surface of mediaboards as one information space (FIG. 6, 8).

The platform controls the priority and sequential broadcast of the content on the single-sector information surface using adaptive calculation algorithms, increasing the efficiency of information perception.

The intelligent information and communication platform operates as follows.

When a vehicle enters the coverage area of a mediaboard digital camera or optical sensors, the analytical equipment complex captures and generates the raw data of the number and speed of each vehicle on the mediaboard computer in the autonomous mode, indicating the vehicle license number and the time when the car passed by. The raw data is then processed and stored on the central computer to form the analytical database and further control the information and its display on the information display device.

When user radio-emitting devices (RFID, NFC, electronic gadgets, such as smartphones, smart watches, cars fitted with onboard radio-emitting devices, such as Bluetooth, Wi-Fi, RFID, etc.) enter the coverage area of the mediaboard analytical equipment complex transceivers, they are detected. The raw data on the number of radio-emitting devices and their signal level is generated, indicating the unique device identification number (MAC address) and time. The central computer processes and stores this raw data to generate analytical data and parameters and manage the information on the information display device.

### User Interaction Functions

When a user approaches a mediaboard and overcomes the threshold settings of the user device ID signal or the user's absolute (relative) geolocation, the user (user's device) previously registered in the platform is detected and verified.

When a user or a vehicle enters the area of optical detection of vehicle license plates, biometric facial identification, or when the mediaboard devices read passive RF tags, QRs, bar codes on wearable documents or radio-emitting device IDs, the transport IDs, user biometric parameters and ID codes registered on the platform are identified and verified.

The nearest mediaboard or information display device then reacts by providing personalized information, navigation-and-information support relevant for that time and location according to the tasks previously configured in the system.

The platform software for aggregating external data requests and receives data independently. This processed data is a part of integrated information generation for display on the platform terminals.

### Dynamic Image

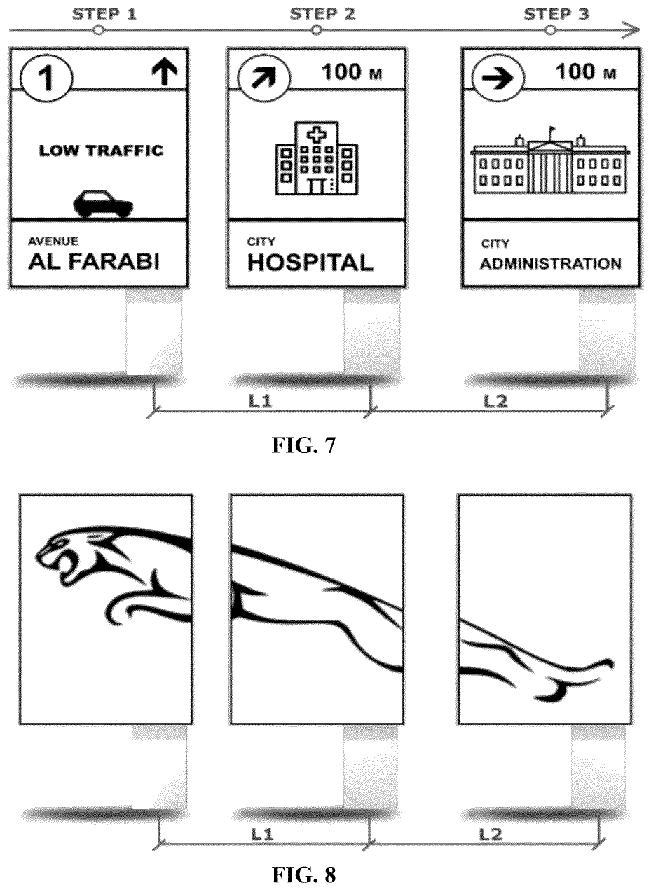

For groups of mediaboards with one information sector combined into a single local information space, techniques for simultaneous placement and adaptive movement of priority information in a cluster of structures are applied (FIG. 7) according to the formula t=L/V, where t is the time of movement of the content, L is the distance between the structures, and V is the speed of the content movement.

Sequential information publishing algorithms are applied (FIG. 8) according to the formula T=L1/V+L2/V+Ln/V, where T is the content publishing time, L1, L2, and Ln indicate the distance between the structures, and V is the speed of the content movement from one structure to another depending on changes in external parameters.

The anamorphosis and parametric techniques (FIG. 9) are also applied to form an integral perception of information content spaced in the cluster of information display devices.

The content and algorithms of information content depend on changes in the traffic situation and event changes in the city space under content tasks for targeted information support and user information support.

Multifunctional and cross-platform technological solutions of the claimed platform are integrated into the urban physical, digital, and communication infrastructure and serve its development in the context of the “Smart City” concept.

The use of the claimed multifunctional information and communication platform with intelligent information management is not limited by road infrastructure. The multifunctional information and communication platform provides applied solutions for different sectors, like Smart Field (ensuring safety at oil and gas fields), Smart Gas Station (solution for fuel stations), Smart Subway (Intelligent transport systems infrastructure), Smart Hub (logistic zones), Smart Venue (tourist complexes, sports entertainment objects, shopping centers), and others.

Technological solutions of the platform for industrial facilities can improve the efficiency of managing technological processes through their complete automation and efficient interaction of the system with the participants in production processes.

System communication efficiency is achieved by personalized and directive interaction of the platform with each participant in the production process by means of visual communication in a convenient and adaptive information perception format.

The system's introduction in the industrial area infrastructure provides:
Highly efficient provision with actual, operative, and adaptive online information in the facility infrastructure;
Improved occupational and labor safety;
Dynamic information control of people traffic in danger areas;
Operational response to emergencies;
Instrumental security to ensure complex safety based on targeted data analysis in the system to detect emergencies and incidents in production areas for adaptive notification and increased people safety;
Automation of route orientation dispatching system;
Automated control of vehicle traffic;
Navigation support for drivers;
Dynamic notification of changes in the technological process.

In logistic zones, information processing and display equipment and algorithms are used to organize the movement of cargo and transport within the terminal. The complex firmware solution includes a multifunctional information and communication platform with intelligent information management based on personalized routing and a complex of interactive LED panels for dynamic visual tracking and controlling the movement of mobile objects in the Terminal area. This solution can provide transport and cargo identification, tracking and regulation of traffic, regulation of technological processes, personalized information support of mobile objects, operative correction of routes, and a dynamic visual navigation system.

As a technical result, using the proposed multifunctional information and communication platform with intelligent information management increases the capacity and volume of information collected, processed, and provided to the users. The platform provides more detailed and customized information (personification of information provided).

What is claimed is:

1. A multifunctional information and communication platform with intelligent information management, comprising a central computer and mediaboards that are located along the user routes and contain devices that collect, transmit, receive, and display information; digital video controllers, a media board onboard computer and transceivers for wired or wireless communication with the central computer, wherein devices for detecting radio signals, recognizing (personalization) of users and their movements, wherein the platform is a software-matting complex comprising:
A software complex;
An analytical equipment complex for information collection and processing;
User interaction instrumentation;
Integration platform software for aggregating external data and information;
A set of equipment that makes up the control system architecture and includes onboard media computers and the central computer;
An information display device equipment complex comprising devices that process and display visual information on an information display device.

2. The multifunctional information and communication platform with intelligent information management, according to claim 1, wherein devices for displaying information are comprised of multiple sectors.

3. The multifunctional information and communication platform with intelligent information management, according to claim 1, wherein mediaboards are joined into clusters.

4. The method of using the platform according to claim 1, comprising collecting, processing, storing, and transmitting data to a central computer for further processing by the analytical complex software with the function of automatic generation and intelligent management of information, with a further output on information display devices of information about:
user location;
traffic;
the closest objects of interest;
possible variants of reaching the objects of interest;
weather conditions;
emergencies.

5. The method of using the platform according to claim 4, wherein it further comprises personalizing the user in the system and providing personalized information to at least one personalized user.

6. The method of using the intelligent information system according to claim 4, wherein it further comprises registration of a user in the system, receiving inquiries from a registered user, processing the inquiry, and outputting personalized information upon request to at least one information display device in close proximity to the user.

7. The method of using the platform according to claim 4, wherein the platform performs automated construction of information content and its output to the information display devices.

8. The method of using the platform according to claim 4, wherein it comprises simultaneous placing and adaptive moving of priority personalized information requested by a user through the platform information display devices.

9. The multifunctional information and communication platform with intelligent information management, according to claim 2, wherein mediaboards are joined into clusters.

10. The method of using the platform according to claim 2, comprising collecting, processing, storing, and transmitting data to a central computer for further processing by the analytical complex software with the function of automatic generation and intelligent management of information, with a further output on information display devices of information about:
user location;
traffic;
the closest objects of interest;
possible variants of reaching the objects of interest;
weather conditions;
emergencies.

11. The method of using the platform according to 3, comprising collecting, processing, storing, and transmitting data to a central computer for further processing by the analytical complex software with the function of automatic generation and intelligent management of information, with a further output on information display devices of information about:
user location;
traffic;
the closest objects of interest;
possible variants of reaching the objects of interest;
weather conditions;
emergencies.

12. The method of using the intelligent information system according to claim 5, wherein it further comprises registration of a user in the system, receiving inquiries from a registered user, processing the inquiry, and outputting personalized information upon request to at least one information display device in close proximity to the user.

13. The method of using the intelligent information system according to claim 5, wherein it further comprises registration of a user in the system, receiving inquiries from a registered user, processing the inquiry, and outputting personalized information upon request to at least one information display device in close proximity to the user.

14. The method of using the platform according to claim 5, wherein the platform performs automated construction of information content and its output to the information display devices.

15. The method of using the platform according to claim 6, wherein the platform performs automated construction of information content and its output to the information display devices.

16. The method of using the platform according to claim 5, wherein it comprises simultaneous placing and adaptive moving of priority personalized information requested by a user through the platform information display devices.

17. The method of using the platform according to claim 6, wherein it comprises simultaneous placing and adaptive moving of priority personalized information requested by a user through the platform information display devices.

18. The method of using the platform according to claim 7, wherein it comprises simultaneous placing and adaptive moving of priority personalized information requested by a user through the platform information display devices.
